(19) United States
(12) Patent Application Publication
(10) Pub. No.: US 2015/0169221 A1
(43) Pub. Date: Jun. 18, 2015

(54) INFORMATION PROCESSING APPARATUS AND METHOD FOR MONITORING THE SAME

(71) Applicant: FUJITSU LIMITED, Kawasaki-shi (JP)

(72) Inventor: Misao Shirasu, Inagi (JP)

(21) Appl. No.: 14/534,637

(22) Filed: Nov. 6, 2014

(30) Foreign Application Priority Data
Dec. 12, 2013 (JP) 2013-256858

(51) Int. Cl. G06F 3/06

(52) U.S. Cl. CPC G06F 3/061; G06F 3/0653; G06F 3/0685; G06F 2003/0692; G06F 2003/0697

(57) ABSTRACT

An apparatus comprises a storage device that stores data therein, a processor that accesses the storage device, a system manager that manages status information regarding the status of a system including the processor and the storage device, an I/O controller that performs access control on the storage device according to a predetermined protocol, and a monitoring unit that, upon detecting predetermined information included in data used by the I/O controller to access the storage device, notifies status information of the storage device based on the predetermined information to the system manager.

### CROSS-REFERENCE TO RELATED APPLICATIONS

This application is based upon and claims the benefit of priority of the prior Japanese Patent Application No. 2013-256858, filed on Dec. 12, 2013, the entire contents of which are incorporated herein by reference.

### FIELD

The present invention relates to an information processing apparatus and a method for monitoring the same.

### BACKGROUND

An agent corresponding to an individual device may be used in order to integrally monitor hardware for various devices mounted in an information processing apparatus such as server or personal computer.

FIG. 8 is a diagram illustrating an exemplary configuration of an information processing apparatus 100. The information processing apparatus 100 comprises a plurality of storage devices 200 such as Hard Disk Drive (HDD) and Solid State Drive (SSD) configuring a Redundant Arrays of Inexpensive Disks (RAID) as illustrated in FIG. 8. The storage devices 200 are exemplary Peripheral Component Interconnect Express (PCIe; Registered Trademark) devices. In the example of FIG. 8, the storage devices 200 setting hardware RAID therein are connected to a RAID controller 310 via a Serial Attached Small Computer System Interface (SAS)/Serial Advanced Technology Attachment (SATA) interface. Further, the storage devices 200 setting software RAID therein are connected to a PCIe controller 320 via a PCIe interface.

In the Operating System (OS) 900 in the information processing apparatus 100, a RAID agent 510 and a SSD agent 520 acquire hardware information from the devices via corresponding RAID driver 410 and SSD driver 420 for the PCIe devices 200, respectively. The hardware information includes status information indicating whether or not at least the PCIe devices 200 normally operate (the presence or absence of a failure). A platform agent 600 collects and aggregates the hardware information from the agents 510 and 520 of the PCIe devices 200, and passes it to an event indicator 700. For example, the platform agent 600 passes a generated event to a Software (S/W) event indicator 720 in a software manner. Alternatively, the platform agent 600 passes a generated event to a Hardware (H/W) event indicator 710 via a Baseboard Management Controller (BMC)/Management Board (MMB) 800. The BMC/MMB 800 is a manager that aggregates and manages events generated in the information processing apparatus 100.

The H/W event indicator 710 and the S/W event indicator 720 perform the processes according to the generated events, respectively. For example, the H/W event indicator 710 transmits Simple Network Management Protocol (SNMP) trap or E-mail, generates hardware logs, controls Light Emitting Diode (LED), and the like. The S/W event indicator 720 generates OS logs, displays popup messages on a screen such as monitor in the information processing apparatus 100, and the like.

As a related technique, there is known a technique in which a plurality of service processors (SVP) are mounted on a storage device and a plurality of processes are distributed in the SVPs (see Japanese Laid-open Patent Publication No. 2006-107080, for example). Thereby, the process in each SVP can be simplified, thereby enabling reliable monitoring.

Patent Document 1: Japanese Laid-open Patent Publication No. 2006-107080

Patent Document 2: Japanese Laid-open Patent Publication No. 2007-515002

Patent Document 3: Japanese Laid-open Patent Publication No. 2006-331392

In the information processing apparatus 100 illustrated in FIG. 8, a dedicated agent for each PCIe device is developed and verified for hardware integrated monitoring. The agents are developed and verified for the kind of OS and a version number thereof. Thus, there is a problem that cost for the total development increases.

Further, there are highly compatible dependences among the modules of the hardware, the firmware, the drivers and the agents for the PCIe devices 200 in many cases. When any one module is updated to its new version, all the modules in the PCIe devices 200 are updated in order to keep the total compatibility. Further, there are similar dependences between the agents 510, 520 and the platform agent 600 for the PCIe devices 200 in many cases. As a result, version update of one module causes all the monitoring modules in the information processing apparatus 100 to be updated to their new versions, which causes a problem that a heavy load for system maintenance is imposed on a manager.

For example, when a PCIe device 200 is replaced due to a hardware failure and the version of the replaced PCIe device 200 is newer than that of the previous hardware and firmware, replacement of the PCIe device 200 causes the entire system to be rapidly updated for compatibility. Further, also when a kernel version number of the OS is updated, update of the kernel version number causes all the modules including the hardware and firmware to be updated.

The above technique in which a plurality of SVPs are mounted on an external storages does not consider the above problems.

As described above, the agents depend on a kind and version number of the OS (basic software), version numbers of the modules of the PCIe devices, and the like, and thus there is a problem that it is difficult for the agents to monitor the storage devices or cost for monitoring increases.

### SUMMARY

According to an aspect of the embodiments, an information processing apparatus includes: a storage device that stores data therein; a processor that accesses the storage device; a system manager that manages status information regarding a status of a system including the processor and the storage device; an I/O controller that performs access control on the storage device according to a predetermined protocol; and a monitoring unit that, upon detecting predetermined information included in data used by the I/O controller to access the storage device, notifies status information of the storage device based on the predetermined information to the system manager.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary hardware configuration of an information processing apparatus according to one embodiment;

FIG. 2 is a diagram illustrating an exemplary functional configuration of the information processing apparatus illustrated in FIG. 1;

FIG. 3 is a diagram illustrating an exemplary data configuration of DDF;

FIG. 4 is a diagram illustrating exemplary monitoring data stored in a register illustrated in FIG. 1;

FIG. 5 is a flowchart for explaining an exemplary process of monitoring a PCIe device by a snoop processing unit illustrated in FIG. 1;

FIG. 6 is a flowchart for explaining an exemplary process of monitoring a PCIe device by the snoop processing unit illustrated in FIG. 1;

FIG. 7 is a flowchart for explaining an exemplary process of monitoring a PCIe device by the snoop processing unit illustrated in FIG. 1;

FIG. 8 is a diagram illustrating an exemplary configuration of an information processing apparatus; and

FIG. 9 is a diagram illustrating an exemplary hardware configuration of the information processing apparatus illustrated in FIG. 8.

### DESCRIPTION OF EMBODIMENT(S)

Hereinafter, an embodiment will be described with reference to the drawings.

### [1] Embodiment

### [1-1] Configuration of Information Processing Apparatus

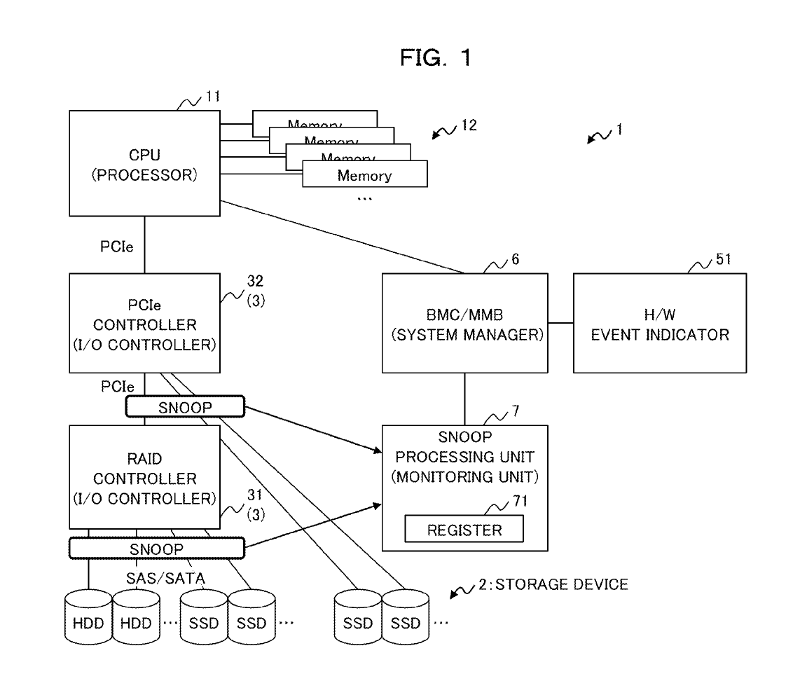

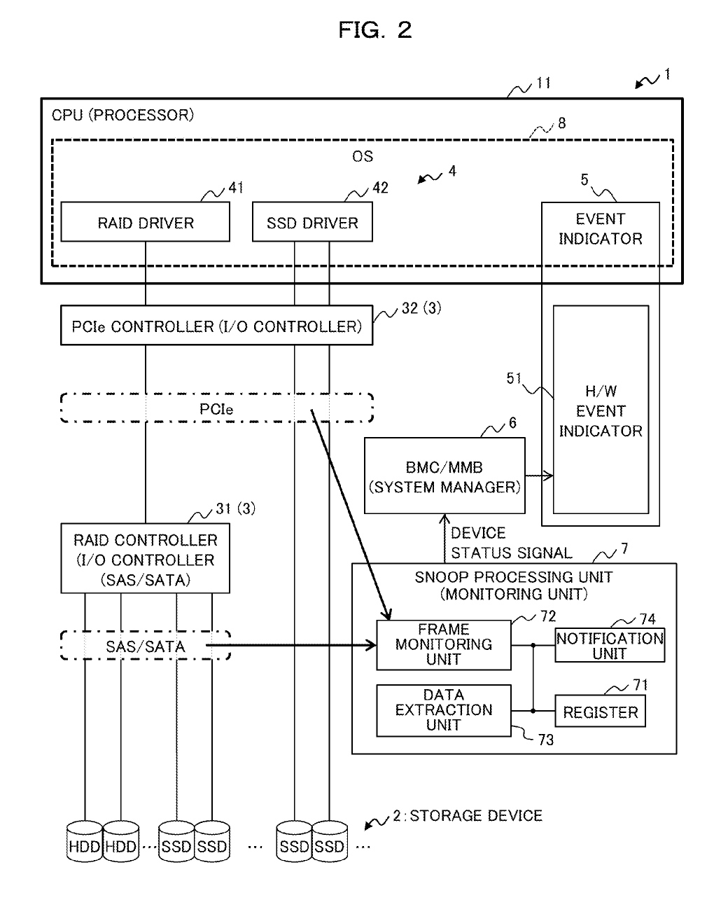

A configuration of an information processing apparatus 1 will be described below as an exemplary embodiment with reference to FIG. 1 and FIG. 2. FIG. 1 is a diagram illustrating an exemplary hardware configuration of the information processing apparatus 1 according to one embodiment, and FIG. 2 is a diagram illustrating an exemplary functional configuration of the information processing apparatus 1 illustrated in FIG. 1.

As illustrated in FIG. 1, the information processing apparatus 1 such as server or personal computer comprises one or more (multiple in FIG. 1) storage devices 2, a RAID controller 31, and a PCIe controller 32 in the hardware configuration. The information processing apparatus 1 further comprises a Central Processing Unit (CPU) 11, one or more (multiple in FIG. 1) memories 12, a H/W event indicator 51, a BMC/MMB 6, and a snoop processing unit 7 in the hardware configuration.

The storage device 2 is hardware that stores various items of data or programs therein, such as magnetic disk device such as HDD, semiconductor drive device such as SSD, or nonvolatile memory such as flash memory. The storage device 2 according to one embodiment is connected to the information processing apparatus 1 via a PCIe interface (or PCIe interface and SAS/SATA interface), and thus the storage device 2 may be denoted as PCIe device 2.

The RAID controller 31 is a switch/controller that manages and controls the RAID configuration using the PCIe devices 2 with hardware RAID, and connects the storage devices 2 via the SAS/SATA interface. The PCIe controller 32 is a switch/controller that connects the storage devices 2 such as SSD capable of PCIe connection via the PCIe interface. The RAID controller 31 is connected to the PCIe controller 32 via the PCIe interface. In the following, when the RAID controller 31 and the PCIe controller 32 are not particularly discriminated from each other, they will be collectively called controllers 3.

The controllers 3 perform access control such as writing data into the storage devices 2 or reading data from the storage devices 2 in response to a request from the RAID driver 41 or SSD driver 42 (see FIG. 2). Herein, the controllers 3 perform access control by use of a protocol corresponding to the PCIe devices 2 such as SAS/SATA protocol or PCIe protocol. That is, the controllers 3 may be exemplary I/O controllers that perform access control on the storage devices 2 according to a predetermined protocol.

The CPU 11 is an exemplary computation processor (processor) connected to the memories 12, the PCIe controller 32, and the BMC/MMB 6 and is directed for performing various control or computations. The CPU 11 executes a program stored in the memories 12 or a Read Only Memory (ROM) (not illustrated) thereby to realize various functions in the information processing apparatus 1. An electronic circuit such as Micro Processing Unit (MPU) may be employed for the processor, not limited to the CPU 11.

The memory 12 is a storage device that stores various items of data or programs therein. Upon executing a program, the CPU 11 stores and develops data or programs in the memories 12. The memory 12 may be a volatile memory such as Random Access Memory (RAM).

For example, the CPU 11 executes the OS 8 including the functions of the RAID driver 41 and the SSD driver 42 as illustrated in FIG. 2.

The RAID driver 41 is software that controls hardware of the RAID controller 31 and/or the PCIe devices 2, and the SSD driver 42 is software that controls hardware of the PCIe devices 2 such as SSD. In the following, when the RAID driver 41 and the SSD driver 42 are not particularly discriminated from each other, they will be collectively called drivers 4. The drivers 4 provide the CPU 11 as a higher device (host) with interfaces to the PCIe devices 2 to be accessed. For example, the drivers 4 convert a request from the CPU 11 according to a predetermined protocol such as SAS, SATA or PCIe corresponding to the PCIe devices 2, thereby to make an instruction (access) to the PCIe devices 2.

The OS 8 can comprise a function of managing and controlling the RAID configuration using the PCIe devices 2 by use of the software RAID. For example, in the example illustrated in FIG. 2, the software RAID executed by the OS 8 manages and controls the RAID configuration for the SSD directly connected to the PCIe controller 32. That is, FIG. 2 illustrates an example in which all the PCIe devices 2 provided in the information processing apparatus 1 configure the RAID.

The H/W event indicator 51 performs a process depending on a generated event. For example, the H/W event indicator 51 transmits SNMP trap or E-mail, generates hardware logs, controls LED, and the like, depending on a generated event. The OS 8 may comprise a function of the event indicator 5 that manages the process results of the H/W event indicator 51 as illustrated in FIG. 2.

The BMC/MMB 6 is an exemplary system manager that controls the information processing apparatus 1 including the CPU 11 and the PCIe devices 2, for example, manages status information regarding a status of the information processing apparatus 1. For example, the BMC/MMB 6 is connected to the components on the baseboard such as the memories 12 and the PCIe devices 2 via a bus such as Inter-Integrated Circuit (I2C; Trademark). The BMC/MMB 6 can collect (aggregate) information such as logs from any component via the bus, and can notify an event generated (detected) in the information processing apparatus 1 to the H/W event indicator 51. Thus, the H/W event indicator 51 is an exemplary notification processing unit that notifies the manager of the information processing apparatus (system) 1 depending on the status information regarding a status of the information processing apparatus (system) 1 notified from the BMC/MMB 6. The BMC/MMB 6 can perform various control such as power supply control of the information processing apparatus 1.

The BMC/MMB 6 comprises a monitoring port such as Local Area Network (LAN) in addition to a data communication port, and the manager or the like can monitor the information processing apparatus 1 by remotely accessing the BMC/MMB 6. The BMC/MMB 6 may comprise a processor such as CPU, MPU, Application Specific Integrated Circuit (ASIC), or Field Programmable Gate Array (FPGA). The function of the BMC/MMB 6 may be realized by executing the software (firmware) held in the storage device of the BMC/MMB 6 by the processing apparatus. The BMC/MMB 6 may realize at least part or all of the control by the H/W event indicator 51 by the function of the software operating on the BMC/MMB 6. For example, the BMC/MMB 6 can transmit SNMP trap or E-mail in the H/W event indicator 51 via the monitoring port.

The snoop processing unit 7 monitors data (data frame) or commands (command frames) (which may be collectively called transfer data below) exchanged between the controllers 3 and the PCIe devices 2 via the PCIe and SAS/SATA protocols. When the transfer data meets a predetermined condition, the snoop processing unit 7 notifies failure/normal of the PCIe devices 2 to the BMC/MMB 6 by an output signal. Thus, the snoop processing unit 7 is connected to any portions between the controllers 3 and the PCIe devices 2 thereby to acquire (snoop) the transfer data as illustrated in FIG. 1 and FIG. 2. Further, the snoop processing unit 7 is connected to the BMC/MMB 6, which enables detected status information of the PCIe devices 2 to be notified. The snoop processing unit 7 may be an electronic circuit, or an integrated circuit such as CPU, MPU, ASIC or FPGA.

That is, the snoop processing unit 7 may be an exemplary monitoring unit that, upon detecting predetermined information included in the transfer data used by a controller 3 to access a PCIe device 2, notifies status information of the PCIe device 2 based on the predetermined information to the BMC/MMB 6.

### [1-2] Exemplary Configuration of Snoop Processing Unit

An exemplary configuration of the snoop processing unit 7 will be described below.

There will be described below an example in which the snoop processing unit 7 monitors the PCIe devices 2 under control of RAID.

The snoop processing unit 7 comprises a register (see FIG. 1), a frame monitoring unit 72, a data extraction unit 73, and a notification unit 74 as illustrated in FIG. 2.

The register 71 is a storage device (storage circuit) that stores monitoring data therein in the snoop processing unit 7. The monitoring data to be stored in the register 71 will be described later.

The frame monitoring unit 72 is directed for monitoring transfer data exchanged between the controllers 3 and the storage devices 2 as illustrated in FIG. 1 and FIG. 2. The frame monitoring unit 72 is connected to the bus between the controllers 3 and the PCIe devices 2, the controllers 3, or the PCIe devices 2, for example, thereby acquiring (snooping) the transfer data. The transfer data can be acquired by various well-known methods, and a detailed description thereof will be omitted.

Specifically, the frame monitoring unit 72 monitors whether or not an access request (write or read command) to the data in a predetermined storage area in the PCIe device 2 is included in the transfer data transmitted from the controller 3 to the PCIe device 2 while monitoring the transfer data. Then, upon determining that the access request is included in the transfer data, the frame monitoring unit 72 determines whether or not predetermined information is included in response data (read data) from the PCIe device 2 for the read command, or the write command. Upon determining that predetermined information is included in the write command or the response data, the frame monitoring unit 72 passes the process to the data extraction unit 73.

Herein, the predetermined storage area is an area in which configuration information regarding the configurations of the PCIe devices 2 is stored, for example, and is commonly defined for the different PCIe devices 2. Further, the predetermined information is included in the configuration information, and includes information regarding the presence or absence of a failure of a PCIe device 2, for example. Further, the configuration information is preferably data which does not depend on any modules (such as hardware, firmware and driver) such as the PCIe devices 2 or the kind/version number and the like of the OS 8 and whose specification is not changed even if the kind/version number and the like are changed (updated). For example, the configuration information is basic data for a redundancy process (RAID) of the PCIe devices 2, which is defined by standard Disk Data Format (DDF).

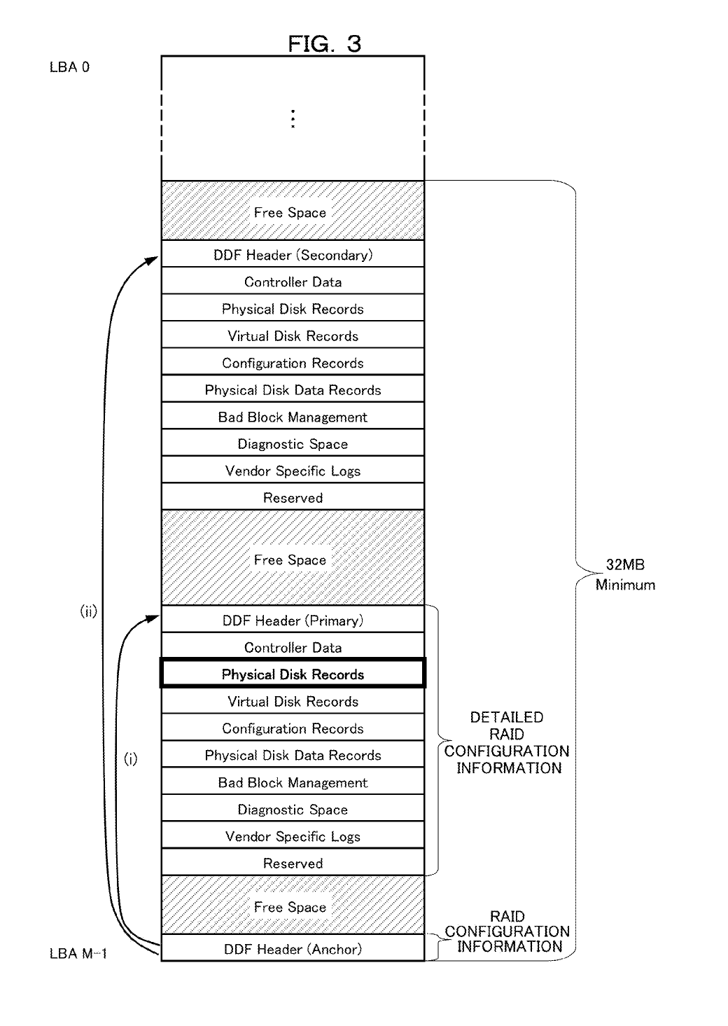

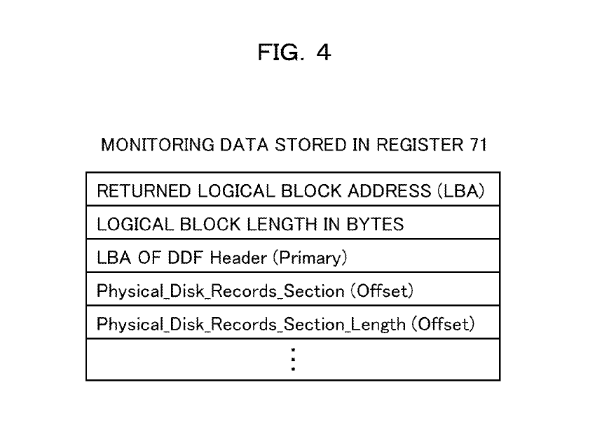

An exemplary configuration of the frame monitoring unit 72 will be more specifically described below with reference to FIG. 3 and FIG. 4. FIG. 3 is a diagram illustrating an exemplary data configuration of DDF, and FIG. 4 is a diagram illustrating exemplary monitoring data stored in the register 71 illustrated in FIG. 1.

Herein, the DDF is a specification which is generally employed by the RAID product venders of a RAID controller and the like and is mounted on the RAID products. With the DDF, “DDF Header (Anchor)” (anchor header) is recorded in the last Logical Block Address (LBA) in a PCIe device 2 such as HDD/SSD as illustrated in FIG. 3. The anchor header records RAID configuration information including simple information regarding the PCIe devices 2, and offset of the storage LBA of the detailed RAID configuration information therein.

Specifically, the anchor header records therein LBA of “DDF Header (Primary)” (primary header) recording the actual statuses of the PCIe devices 2 (see the arrow (i) in FIG. 3). The detailed RAID configuration information has a predetermined-sized area including the primary header as illustrated in FIG. 3, and includes detailed information regarding the PCIe devices 2 including the information (predetermined information) regarding the presence or absence of a failure of the PCIe devices 2. The anchor header records therein LBA of “DDF Header (Secondary)” (secondary header) as redundant data of the primary header as needed (see the arrow (ii) in FIG. 3).

In many cases, each hardware is of a different development vendor and is mounted in a vendor-unique manner in the open system. Thus, monitoring with only hardware is difficult if it is not standardized. Alternatively, it takes a long time to be standardized due to protracted standardization and protracted mounting of the standards of all the PCIe devices. Thus, it is difficult to develop an information processing apparatus mounting a hardware integrated monitoring function thereon in a short time.

To the contrary, with the information processing apparatus 1 according to one embodiment, the snoop processing unit 7 monitors the PCIe devices 2 by use of the information regarding the presence or absence of a failure of the PCIe devices 2 stored in the predetermined areas commonly defined in the different PCIe devices 2. Thus, the system vendor of the information processing apparatus 1 can solely mount the mechanism for monitoring the PCIe device 2 not depending on each hardware development vendor of the PCIe devices 2 and the like. Each development vendor does not need to additionally mount for hardware monitoring. As a result, the system vendor can develop the information processing apparatus 1 mounting the hardware integrated monitoring function thereon in a short time. Further, cost for monitoring the PCIe device 2 can be reduced in both the system vendor and the development vendor.

In the following, it is assumed that the predetermined area is an area from the last LBA to the LBA of the primary header (area including the RAID configuration information and the detailed RAID configuration information) and the configuration information is data stored in the area from the last LBA to the LBA of the primary header.

The frame monitoring unit 72 starts to monitor data transactions via SAS/SATA/PCIe after the information processing apparatus 1 is activated, and detects SCSI/ATA command frames and PCIe command frames from the controllers 3. Then, when the operation code of a detected command is a read command of the last sector (final sector) in the PCIe device 2, the frame monitoring unit 72 determines a response data frame from the PCIe device 2 corresponding to the read command. The read command of the last sector in the PCIe device 2 may be “Read Capacity Command (0x25)” for SAS and “READ NATIVE MAX ADDRESS (0xF8)” for SATA.

The description will be made below assuming that the interfaces of the controllers 3 correspond to SAS and the controllers 3 transmit the SAS commands to the PCIe devices 2, and this is applicable to the interfaces and commands corresponding to SATA or PCIe.

The frame monitoring unit 72 extracts data indicating the address of the last sector requested in the read command from the response data frame, and stores it in the register 71. The data indicating the address of the last sector may be data having 8 bytes in total including “RETURNED LOGICAL BLOCK ADDRESS” (4 bytes) and “LOGICAL BLOCK LENGTH IN BYTES” (4 bytes) (see FIG. 4). Herein, “RETURNED LOGICAL BLOCK ADDRESS” indicates LBA of the anchor header, and “LOGICAL BLOCK LENGTH IN BYTES” indicates a block size of the anchor header. The block size of the anchor header is generally 512 bytes in many cases, and thus the frame monitoring unit 72 may omit extracting “LOGICAL BLOCK LENGTH IN BYTES.”

The description will be made below assuming that “LOGICAL BLOCK LENGTH IN BYTES” has 512 bytes.

In this way, the frame monitoring unit 72 can detect the last address of the PCIe device 2, or LBA of the anchor header. After the information processing apparatus 1 is activated, the CPU 11 or the controllers 3 first issue the read command of the last sector to the PCIe device 2 for recognizing the last address of each PCIe device 2. Thus, the frame monitoring unit 72 can accurately detect LBA of the anchor header by use of the nature of the CPU 11 or the controllers 3.

Further, upon detecting LBA of the anchor header with the above process, the frame monitoring unit 72 detects the SCSI/ATA command frames and the PCIe command frames from the controllers 3 while monitoring the data transactions. The frame monitoring unit 72 then determines whether or not the operation code of a detected command is a write or read command and is an access request to the last sector (anchor header).

When the operation code is a read command to the last sector, the frame monitoring unit 72 determines a response data frame from the PCIe device 2 for the read command. When the operation code is a write command to the last sector, the frame monitoring unit 72 refers to the write data frame in the next process. Both the write data frame and the response data frame will be simply called data frame below.

The frame monitoring unit 72 detects that a value 4 bytes away from the data offset “0x00” of the last sector included in the data frame is a signature (such as “0xDE11DE11”) indicating a format of DDF. Thereby, the frame monitoring unit 72 can detect that the PCIe device 2 conforms to the DDF standard.

The write command may be “Write(10)-0x2A”, “Write(12)-0xAA”, “Write(16)-0x8A”, and the like, and the read command may be “Read(10)-0x28”, “Read(12)-0xA8”, “Read(16)-0x88”, and the like (numbers in brackets indicate a difference in address width). Further, the frame monitoring unit 72 can determine whether or not the command is an access request to the last sector with reference to the write or read command Command Descriptor Block (CDB) or the control area. Specifically, the frame monitoring unit 72 may determine whether or not LBA of a data transfer destination matches with (or includes) “RETURNED LOGICAL BLOCK ADDRESS” stored in the register 71 based on the access LBA in CDB of the write or read command and the number of transfer blocks.

The frame monitoring unit 72 stores the following data into the register 71 from the data frame to/from the last sector (see FIG. 4). The following offsets indicate an offset from the header address (“DDF Header (primary)”) of the anchor header.
LBA of “DDF Header (Primary)”: such as a value 8 bytes away from offset “0x60.”
“Physical_Disk_Records_Section”: offset of area storing status of PCIe device 2 therein (see “Physical Disk Record” in bold frame in FIG. 3) such as a value 4 bytes away from offset “0xC8”.
“Physical_Disk_Records_Section_Length”: the number of sectors in “Physical_Disk_Records_Section,” such as a value 4 bytes away from offset “0xCC.”

In this way, the frame monitoring unit 72 can detect the address of the area storing the status of the PCIe device 2 therein, such as the offset of “Physical_Disk_Records_Section.”

With the above processes, the snoop processing unit 7 can acquire the monitoring data used to acquire the statuses of the PCIe devices 2.

The frame monitoring unit 72 then monitors and detects transfer data including the statuses of the PCIe devices 2 by use of the monitoring data. Specifically, the frame monitoring unit 72 detects the SCSI/ATA command frames and the PCIe command frames from the controllers 3 while monitoring the data transactions. The frame monitoring unit 72 then determines whether or not the operation code of a detected command is a write or read command and an access request to the primary header.

The frame monitoring unit 72 can determine whether or not the command is an access request to the primary header with reference to the CDB of the write or read command. Specifically, the frame monitoring unit 72 may determine whether or not LBA of the data transfer destination matches with (or includes) LBA of “DDF Header (Primary)” stored in the register 71 based on access LBA in CDB of the write or read command and the number of transfer blocks.

When the operation code is a read command for the primary header, the frame monitoring unit 72 determines a response data frame from the PCIe device 2 for the read command, and passes it to the data extraction unit 73. When the operation code is a write command to the primary header, the frame monitoring unit 72 passes the write data frame to the data extraction unit 73.

When the frame monitoring unit 72 determines that the predetermined information is included in the write command or response data, the data extraction unit 73 extracts the predetermined information from the write command or response data.

Specifically, the data extraction unit 73 monitors the transfer data ahead of the offset (offset stored in the register 71) “Physical_Disk_Records_Section” from the primary header included in the write command or response data frame. At this time, the data extraction unit 73 refers to the value in “Physical_Disk_Entries” which is transfer data ahead of the offset “0x40” from “Physical_Disk_Records_Section.” Herein, the status information of each PCIe device 2 is stored in “Physical_Disk_Entries” per 64 bytes, for example. Specifically, bit 1 data in the offset “0x1E” of “Physical_Disk_Entries” corresponds to the information (predetermined information) regarding the presence or absence of a failure of the PCIe device 2. That is, the data extraction unit 73 refers to the value of the bit 1 data in the offset “0x1E” per 64 bytes in “Physical_Disk_Entries”, thereby acquiring the information regarding the presence or absence of a failure of each PCIe device 2.

The data extraction unit 73 may store the acquired information regarding the presence or absence of a failure of each PCIe device 2 in the register 71 or other storage device.

When the data transfer from “Physical_Disk_Records_Section”, which is as much as the sectors of “Physical_Disk_Records_Section_Length”, is completed, the frame monitoring unit 72 returns to the transfer data monitoring again.

That is, the snoop processing unit 7 can subsequently wait an access to the predetermined area in other (or the same) PCIe device 2 to occur after outputting the status signal to the BMC/MMB 6 with the above processes. Then, the snoop processing unit 7 can extract the predetermined information from “Physical_Disk_Entries” and output the status signal each time the predetermined area is accessed.

The example illustrated in FIG. 4 demonstrates that one set of monitoring data is stored in the register 71. The monitoring data may be commonly used in the PCIe devices 2, and since LBA is different when the storage capacities of the PCIe devices 2 are mutually different, the frame monitoring unit 72 may store the monitoring data in the register 71 for each PCIe device 2.

As described above, since “Physical_Disk_Entries” includes 64-byte information for each PCIe device 2, the data extraction unit 73 can acquire the statuses of all the PCIe devices 2 with reference to “Physical_Disk_Entries” of one PCIe device 2. Thereby, when the command frame is to access the predetermined area, the snoop processing unit 7 may acquire the predetermined information from the data frame, thereby reducing monitoring loads.

The notification unit 74 notifies the status signal (status information) of the PCIe device 2 to the BMC/MMB 6 based on the status of each PCIe device 2 acquired by the data extraction unit 73. For example, the notification unit 74 sets the output to the BMC/MMB 6 at “Low” (normal PCIe device 2) when all the items of bit 1 data in the offset “0x1E” per 64 bytes in “Physical_Disk_Entries” are “0” (normal). On the other hand, the notification unit 74 sets the output to the BMC/MMB 6 at “High” (failed or abnormal PCIe device 2) when any one item of bit 1 data is “1” (failure, abnormal).

As described above, the notification unit 74 notifies the status signal of the PCIe device 2 to the BMC/MMB 6 depending on the value of the predetermined information in “Physical_Disk_Entries.” The notification unit 74 may notify the information for identifying a failed PCIe device 2 to the BMC/MMB 6.

The BMC/MMB 6 notified of the status signal of the PCIe device 2 from the notification unit 74 aggregates the status information of each module in the information processing apparatus 1 including the PCIe device 2, and notifies it to the H/W event indicator 51. The H/W event indicator 51 then notifies the manager or the like of the aggregated status information depending on the status information notified from the BMC/MMB 6.

As described above, the snoop processing unit 7 monitors the frames, stores at least the information used for monitoring in the register 71, and outputs the status signal of the PCIe device 2 to the BMC/MMB 6 when a frame to be monitored meets a predetermined condition.

Specifically, the snoop processing unit 7 snoops the device control data transactions such as referring to the DDF data (predetermined area) exchanged via PCIe or SAS/SATA and updating the contents. The snoop processing unit 7 then uses the data acquired by the snooping for displaying a detected failure of a redundant part (PCIe device 2) or hardware information, which is not target for the data transactions, thereby monitoring (monitoring statuses of) a failure of the PCIe devices 2, and the like.

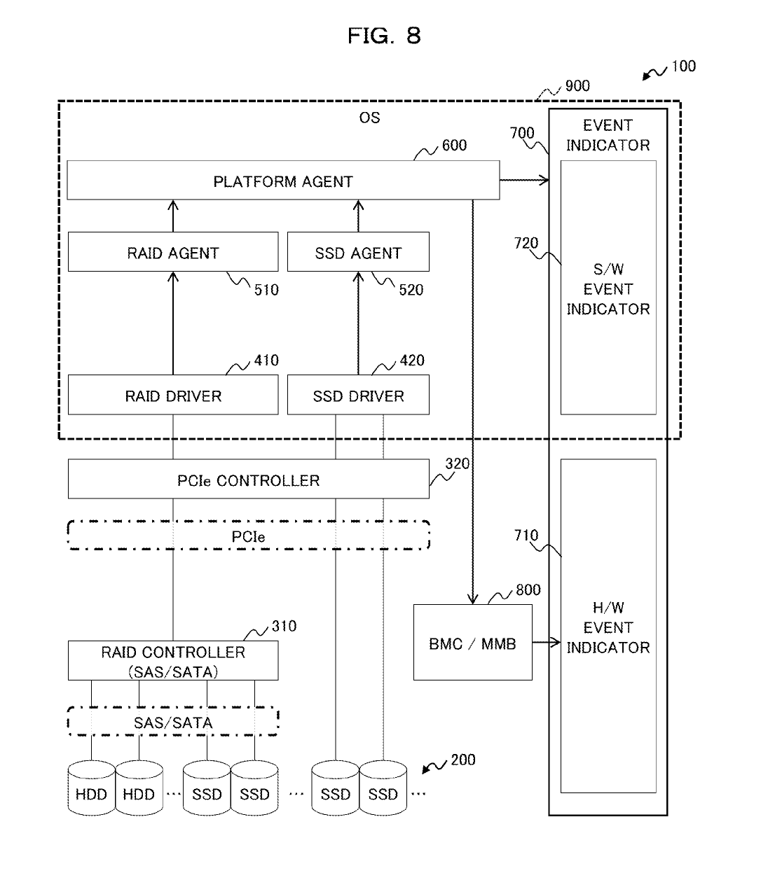

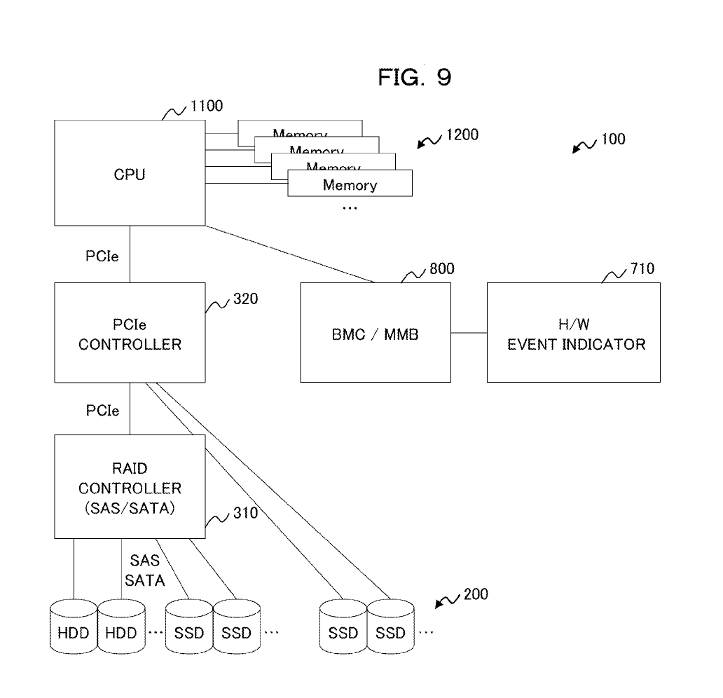

For hardware monitoring, the BMC/MMB for monitoring control or its higher agent (platform agent) generally performs integrated monitoring. FIG. 9 is a diagram illustrating an exemplary hardware configuration of an information processing apparatus 100 illustrated in FIG. 8. For example, as illustrated in FIG. 9, with the conventional method, a BMC/MMB 800 or CPU 1100 (OS 900) collects information regarding the failures detected by a RAID controller 310, a PCIe controller 320, a memory 1200, and the like for integrated monitoring.

To the contrary, the BMC/MMB 6 can collect the information regarding a failure of a PCIe device 2 detected by the controller 3 via the snoop processing unit 7 between the other lower controller 3 than the controller 3 and the PCIe device 2 as illustrated in FIG. 1.

Therefore, the information processing apparatus 1 can omit the configuration of a RAID agent 510, a SSD agent 520, a platform agent 600, and a S/W event indicator 720 as illustrated in FIG. 8. With the information processing apparatus 1 according to one embodiment, a dedicated agent for each PCIe device 2 does not need to be developed and verified for hardware integrated monitoring due to the agent-less monitoring by hardware and firmware. That is, the kind or version number of the OS 8, the version numbers of the modules in the PCIe devices 2, and the like do not need to be considered, thereby reducing cost for monitoring the PCIe controller 32. Compatible dependences among the modules of the PCIe devices 2 do not need to be considered, thereby reducing manager's loads for system maintenance. Further, the agents operating on the OS 8 can be omitted, thereby reducing the process loads of the OS 8.

The snoop processing unit 7 uses (acquires) the data being interface-transferred between the controllers 3 and the PCIe devices 2, not the data recorded in any recording medium, thereby extracting predetermined information. Thus, it can detect a failure of a PCIe device 2 soon after a controller 3 detects it.

Further, the snoop processing unit 7 identifies a position (offset) where predetermined information is stored in the predetermined area by monitoring the transfer data exchanged between the controllers 3 and the PCIe devices 2. Thus, even if the storage capacities of the PCIe devices 2 are mutually different, the position where predetermined information is stored can be adaptively identified.

As described above, it is possible to monitor the PCIe devices 2 easily or at low cost with the information processing apparatus 1 according to one embodiment.

### [1-3] Exemplary Operations

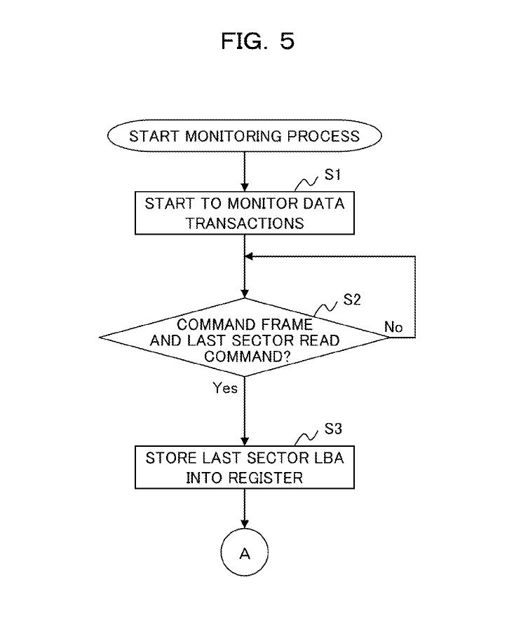

Exemplary operations of the information processing apparatus 1 (the snoop processing unit 7) will be described below as an example of the embodiment having the above configuration with reference to FIG. 5 to FIG. 7.

FIGS. 5 to 7 are the flowcharts for explaining the exemplary process of monitoring the PCIe devices 2 by the snoop processing unit 7 illustrated in FIG. 1.

The description will be made below assuming that the interface of the controllers 3 is compatible with SAS and the controllers 3 transmit SAS commands to the PCIe devices 2. The description will be further made assuming that the size “LOGICAL BLOCK LENGTH IN BYTES” of the last sector of the PCIe devices 2 is generally 512 bytes. Furthermore, the description will be made assuming that the write/read commands are generally “Write(10)”/Read(10)” commands, respectively.

At first, as illustrated in FIG. 5, when the power supply of the information processing apparatus 1 is turned on, the frame monitoring unit 72 in the snoop processing unit 7 starts to monitor data transactions in SAS/SATA/PCIe (step S1). The frame monitoring unit 72 keeps waiting for the SCSI/ATA command frames, for example, while monitoring the data transactions.

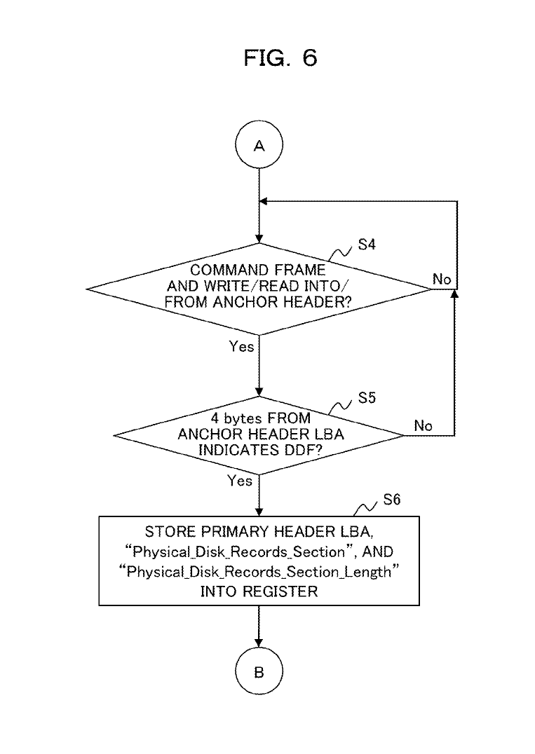

Then, upon detecting a SCSI/ATA command frame, the frame monitoring unit 72 determines whether or not the operation code of the command is a read command of the last sector (step S2). When the operation code of the command is not a read command of the last sector (No in step S2), the process in step S2 is looped until a read command of the last sector is received. On the other hand, when the operation code of the command is a read command of the last sector (Yes in step S2), the frame monitoring unit 72 determines a response data frame corresponding to the read command of the last sector. The frame monitoring unit 72 then stores 8-byte data (RETURNED LOGICAL BLOCK ADDRESS” and “LOGICAL BLOCK LENGTH IN BYTES”) corresponding to the address of the last sector in the register 71 (step S3), and the process transits to FIG. 6.

Then, as illustrated in FIG. 6, the frame monitoring unit 72 keeps monitoring the data transactions. At this time, the frame monitoring unit 72 keeps waiting for the command frames.

Upon detecting a command frame, the frame monitoring unit 72 determines whether or not the operation code of the command is a write or read command for the anchor header (step S4). At this time, the frame monitoring unit 72 determines whether or not the data transfer LBA matches with “RETURNED LOGICAL BLOCK ADDRESS” stored in the register 71 based on the access LBA in CDB of the write/read command and the number of transfer blocks. When it is not a write or read command for the anchor header (No in step S4), the process in step S4 is looped until a write or read command for the anchor header is received. On the other hand, when it is a write or read command for the anchor header (Yes in step S4), the frame monitoring unit 72 performs the process in step S5.

In step S5, the frame monitoring unit 72 detects a data frame corresponding to the write/read command, and determines whether or not it is a signature indicating that the value 4 bytes away from the data offset “0x00” of the last sector is DDF. For example, the frame monitoring unit 72 determines whether or not the value 4 bytes away from the data offset “0x00” of the last sector is “0xDE11DE11”. When the 4-byte value does not indicate DDF (No in step S5), the process proceeds to step S4. On the other hand, when the 4-byte value indicates DDF (Yes in step S5), the frame monitoring unit 72 performs the process in step S6.

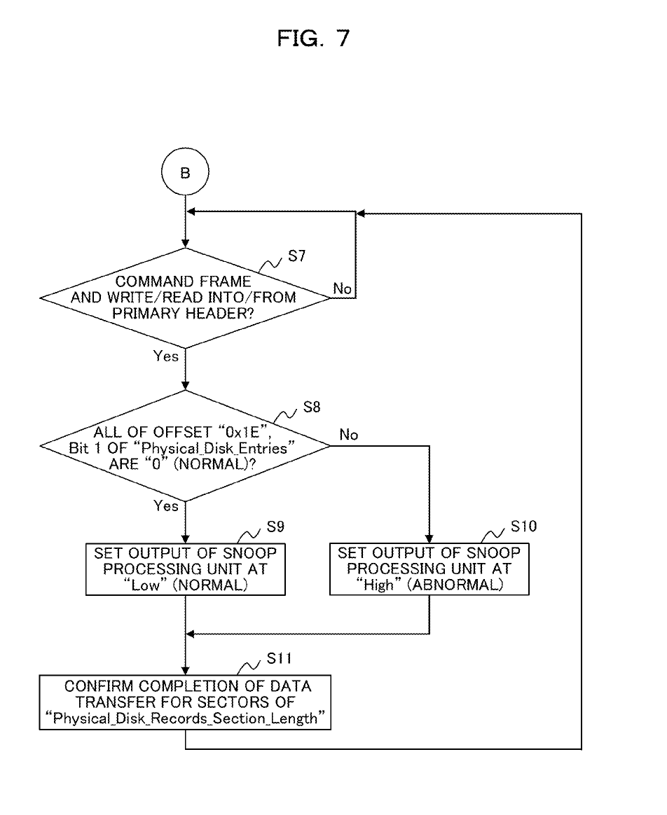

In step S6, the frame monitoring unit 72 detects the following items of data from the data frame to/from the last sector to be stored in the register 71, and the process transits to FIG. 7. The following offsets indicate the offsets from the header address “DDF Header (primary)” of the anchor header.
LBA of “DDF Header (Primary)”
“Physical_Disk_Records_Section” (offset)
“Physical_Disk_Records_Section_Length” (offset)

Then, as illustrated in FIG. 7, the frame monitoring unit 72 keeps monitoring the data transactions. At this time, the frame monitoring unit 72 keeps waiting for the command frames.

Upon detecting a command frame, the frame monitoring unit 72 determines whether or not the operation code of the command is a write or read command for the primary header (step S7). At this time, the frame monitoring unit 72 determines whether or not the data transfer LBA matches with LBA of “DDF Header (Primary)” stored in the register 71 based on the access LBA in CDB of the write/read command and the number of transfer blocks. When it is not a write or read command for the primary header (No in step S7), the process in step S7 is looped until a write or read command for the primary header is received. On the other hand, when it is a write or read command for the primary header (Yes in step S7), the data extraction unit 73 performs the process in step S8.

In step S8, the data extraction unit 73 monitors the transfer data ahead of the offset (offset stored in the register 71) “Physical_Disk_Records_Section” from the primary header included in the data frame. At this time, the data extraction unit 73 refers to the value in “Physical_Disk_Entries” which is transfer data ahead of the offset “0x40” from “Physical_Disk_Records_Section.” The data extraction unit 73 then acquires a value of the bit 1 data in the offset “0x1E” per 64 bytes in “Physical_Disk_Entries.”

The notification unit 74 then determines whether or not all the items of bit 1 data in the offset “0x1E” per 64 bytes in “Physical_Disk_Entries” are “0” (normal). When all is “0” (Yes in step S8), the notification unit 74 sets the output of the snoop processing unit 7 at “Low”, and notifies that the status of the PCIe device 2 is normal to the BMC/MMB 6 (step S9), and the process proceeds to step S11. On the other hand, when any one item of bit 1 data is “1” (failure, abnormal) (No in step S8), the notification unit 74 sets the output of the snoop processing unit 7 at “High.” The notification unit 74 further notifies that the status of the PCIe device 2 is failed or abnormal to the BMC/MMB 6 (step S10), and the process proceeds to step S11.

In step S11, the frame monitoring unit 72 confirms that the transfer of data as much as the sectors of “Physical_Disk_Records_Section_Length” from “Physical_Disk_Records_Section” is completed, and the process proceeds to step S7. In this way, the snoop processing unit 7 generates monitoring data in steps S1 to S6, and thus may acquire the second and subsequent “Physical_Disk_Entries” by repeating the processes in steps S7 to S11.

### [2] Others

The preferred embodiment according to the present invention has been described above in detail, but the present invention is not limited to the specific embodiment, and may be variously modified and changed within the scope without departing from the spirit of the present invention.

For example, the description has been made assuming that the storage devices 2 employ the interfaces such as PCIe and SAS/SATA, but the interfaces are not limited thereto, and other interfaces enabling the snoop processing unit 7 to snoop may be employed.

The description has been made assuming that the frame monitoring unit 72 monitors data exchanged between the controllers 3 and the PCIe devices 2, but the frame monitoring unit 72 is not limited thereto. At least part of the configuration of the snoop processing unit 7 including the frame monitoring unit 72 may be provided in the controllers 3, for example. In this case, the frame monitoring unit 72 may monitor data exchanged between the controllers 3 and the PCIe devices 2.

The hardware configuration of the information processing apparatus 1 described above are only exemplary. For example, the components (hardware or software (firmware)) may be increased/decreased, divided, or integrated in any combination in each controller 3, the BMC/MMB 6, the H/W event indicator 51, and the snoop processing unit 7 as needed.

The description has been made assuming that the snoop processing unit 7 monitors the PCIe devices 2 under control of RAID, but the PCIe devices 2 are not limited thereto. For example, any PCIe device 2 for which an area in which information regarding the presence or absence of a failure of the PCIe device 2 is recorded is previously known (which desirably uses a standardized specification) can be controlled as described above even if it does not configure RAID, for example.

According to one embodiment, it is possible to monitor a storage device easily or at low cost.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a storage device that stores data therein;
a processor that accesses the storage device;
a system manager that manages status information regarding a status of a system including the processor and the storage device;
an I/O controller that performs access control on the storage device according to a predetermined protocol; and
a monitoring unit that, upon detecting predetermined information included in data used by the I/O controller to access the storage device, notifies status information of the storage device based on the predetermined information to the system manager.

2. The information processing apparatus according to claim 1,
wherein the monitoring unit monitors data exchanged between the I/O controller and the storage device, and when an access request to data in a predetermined storage area in the storage device is included in data transmitted from the I/O controller to the storage device, determines whether or not the predetermined information is included in the access request or response data from the storage device for the access request.

3. The information processing apparatus according to claim 2,
wherein the predetermined storage area is commonly defined in a plurality of storage devices including the storage device, and stores configuration information regarding a configuration of the storage device therein, and
the predetermined information is information regarding the presence or absence of a failure of the storage device included in the configuration information.

4. The information processing apparatus according to claim 2,
wherein the monitoring unit identifies a position where the predetermined information is stored in the predetermined area by monitoring data exchanged between the I/O controller and the storage device.

5. The information processing apparatus according to claim 1,
wherein the monitoring unit acquires data being transferred between the I/O controller and the storage device, and upon detecting predetermined information included in the acquired data, notifies status information of the storage device based on the predetermined information to the system manager.

6. The information processing apparatus according to claim 1, further comprising:
a notification processing unit that make a notification to a manager of the system depending on the status information of the system notified from the system manager,
wherein the system manager aggregates the status information of the storage device notified from the monitoring unit into status information of the system, and notifies the aggregated status information of the system to the notification processing unit.

7. A monitoring method in an information processing apparatus including a storage device that stores data therein, a processor that accesses the storage device, and a monitoring unit that monitors the storage device, the monitoring method comprising:
by the monitoring unit,
detecting predetermined information included in data used to access the storage device by an I/O controller that performs access control on the storage device according to a predetermined protocol, and
notifying status information regarding a status of the storage device based on the predetermined information to a system manager that manages status information of a system including the processor and the storage device.

8. The monitoring method according to claim 7, further comprising:
by the monitoring unit,
monitoring data exchanged between the I/O controller and the storage device, and
when an access request to data in a predetermined storage area in the storage device is included in data transmitted from the I/O controller to the storage device, determines whether or not the predetermined information is included in the access request or response data from the storage device for the access request.

9. The monitoring method according to claim 8,
wherein the predetermined storage area is commonly defined in a plurality of storage devices including the storage device, and stores configuration information regarding a configuration of the storage device therein, and
the predetermined information is information regarding the presence or absence of a failure of the storage device included in the configuration information.

10. The monitoring method according to claim 8, further comprising:
by the monitoring unit,
identifying a position where the predetermined information is stored in the predetermined area by monitoring data exchanged between the I/O controller and the storage device.

11. The monitoring method according to claim 7, further comprising:
by the monitoring unit,
acquiring data being transferred between the I/O controller and the storage device, and
upon detecting predetermined information included in the acquired data, notifying status information of the storage device based on the predetermined information to the system manager.

12. The monitoring method according to claim 7, further comprising:
by the system manager,
aggregating the status information of the storage device notified from the monitoring unit into status information of the system, and
notifying the aggregated status information of the system to a notification processing unit that makes a notification to a manager of the system according to the status information of the system.
